(19) United States
(12) Patent Application Publication
(10) Pub. No.: US 2022/0239215 A1
(43) Pub. Date: Jul. 28, 2022

(54) Power Supply Control Device

(71) Applicant: Rohm Co., Ltd., Kyoto (JP)

(72) Inventors: Takatsugu Wachi, Kyoto (JP); Shidong GUAN, Kyoto (JP)

(21) Appl. No.: 17/570,644

(22) Filed: Jan. 7, 2022

(30) Foreign Application Priority Data
Jan. 22, 2021 (JP) 2021008766

(51) Int. Cl. H02M 1/00; H02M 3/158

(52) U.S. Cl. CPC H02M 1/0029; H02M 3/158

(57) ABSTRACT

The present disclosure provides a power supply control device. The power supply control device includes an error amplifier, generating an error voltage according to a difference between a feedback voltage and a reference voltage; a slope voltage generation circuit, generating a slope voltage of a lamp waveform according to an inductor current; a reference voltage generation circuit, generating the reference voltage that depends on an output voltage; a first comparator, generating a reset signal by comparing the error voltage and the slope voltage; a second comparator, generating a skip signal by comparing the error voltage and the reference voltage; an oscillator, generating a set signal; and a controller, receiving an input of each of the signals (set, reset and skip) and performing a switching drive of an output stage in either a fixed on-time control operation or a fixed frequency current mode operation.

### TECHNICAL FIELD

The present disclosure relates to a power supply control device.

### BACKGROUND

A circuit for switching power supply for forming a switching power supply device is conventionally available in the prior art (for example, referring to patent publication 1 of the applicant of the present application).

### PRIOR ART DOCUMENT

### Patent Publication

[Patent document 1] Japan Patent Publication No. 2020-89043

### SUMMARY

### Problems to be Solved by the Disclosure

However, there remains room for further research for handling a wide input voltage, maintaining a current detection gain, or simplifying a circuit.

The disclosure of the present application is brought forth in view issues discovered by the applicant of the present application, in an objective of providing a power supply control device capable of achieving effects of handling a wide input voltage, maintaining a current detection gain, or simplifying a circuit.

### Technical Means for Solving the Problem

For example, a power supply control device disclosed by the present application is configured to control an output stage of a switching power supply that generates an output voltage from an input voltage, and includes: an error amplifier, configured to generate an error voltage according to a difference between a feedback voltage corresponding to the output voltage and a predetermined reference voltage; a slope voltage generating circuit, configured to generate a slope voltage of a ramp waveform according to an inductor current flowing during the output stage, wherein a slope of the ramp waveform depends on the input voltage; a reference voltage generating circuit, configured to generate a consulting voltage dependent on the output voltage; a reset comparator, configured to generate a reset signal by comparing the error voltage with the slope voltage; a skip comparator, configured to generate a skip signal by comparing the error voltage with the consulting voltage; an oscillator, configured to generate a set signal of a fixed frequency; and a controller, configured to perform a switching drive of the output stage in either a fixed on-time control operation or a fixed frequency current mode operation by receiving inputs of the set signal, the reset signal, and the skip signal.

Moreover, for example, a current detection circuit disclosed by the present application is configured to sample a switching voltage present at the output stage of the switching power supply during an off time of the output stage, and use the switching voltage as a current detection voltage for a hold output during an on time of the output stage, and includes: a capacitor circuit, configured to have a first capacitance value in a sampling period of the switching voltage, and to have a second capacitance value smaller than the first capacitance value in a hold period of the current detection voltage; and a sensing amplifier, configured to generate the current detection voltage according to a charging voltage of the capacitor circuit.

Moreover, for example, a slope voltage generating circuit disclosed by the present application includes: a capacitor circuit, configured to sample a switching voltage present at an output stage of a switching power supply in an off time of the output stage, and to use the switching voltage as a current detection voltage for a hold output during an on time of the output stage; and a current source, generating a slope voltage obtained by adding the current detection voltage with a ramp voltage by flowing a charging current into the capacitor circuit during the on time.

Other features, elements, steps, advantages and characteristics are to become more readily apparent with the specific embodiments described with the accompanying drawings below.

### Effects of the Present Disclosure

A power supply control device is provided according to the disclosure of the present application to achieve effects of handling a wide input voltage, maintaining a current detection gain, or simplifying a circuit.

### BRIEF DESCRIPTION OF THE DRAWINGS

FIG. 1 is a diagram of a switching power supply according to a first embodiment.

FIG. 2 is a diagram of an example of a fundamental switching control.

FIG. 3 is a diagram of waveforms that vary with changes in a load.

FIG. 4 is a diagram of an example of a pulse skip control.

FIG. 5 is a diagram of an exemplary operation of a fixed on-time control operation.

FIG. 6 is a diagram of a main part of a power supply control device according to the first embodiment.

FIG. 7 is a diagram of a switching power supply according to a second embodiment.

FIG. 8 is a diagram of a first configuration example of a current detection circuit.

FIG. 9 is a diagram of a second configuration example of a current detection circuit.

FIG. 10 is a diagram of an exemplary operation of a current detection circuit of the second configuration example.

FIG. 11 is a diagram of a switching power supply according to a third embodiment.

FIG. 12 is a diagram of a main part of a power supply control device according to the third embodiment.

FIG. 13 is a schematic diagram of a superimposing process of current information and a ramp waveform.

FIG. 14 is a diagram of an exemplary operation of a slope voltage generating circuit.

FIG. 15 is a diagram of an exemplary combination of the second embodiment and the third embodiment.

### DETAILED DESCRIPTION OF THE EMBODIMENTS

### First Embodiment

### [Switching Power Supply]

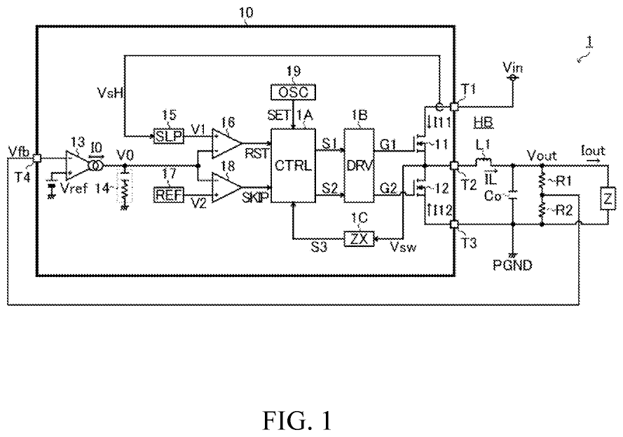

FIG. 1 shows a diagram of a switching power supply 1 according to a first embodiment. The switching power supply 1 of this embodiment is a step-down direct-current/direct-current (DC/DC) converter that generates a DC output voltage Vout (<Vin) from a DC input voltage Vin to a load Z, and includes a power supply control device 10, and various discrete components (for example, an inductor L1, a capacitor C0, and resistors R1 and R2) disposed externally on the power supply control device 10.

Moreover, the switching power supply 1 is most suitable for use as a low-consumption power supply for a field-programmable gate array (FPGA) that is accompanied by high-functioning numerically controlled (NC) machine tools, or a low-consumption power supply for a communication unit system suitable for 5G.

The power supply control device 10 is a semiconductor integrated circuit (IC) (a so-called power control IC) configured to control a half-bridge output stage HB (including an output element 11, a rectifying element 12, the inductor L1 and the capacitor Co given in the description below) of the switching power supply 1. In addition, the power supply control device 10 includes external terminals T1 to T4 as mechanisms for establishing electrical connections with the outside of the device. External terminals (such as a connection terminal for a step-up capacitor) other than those above may also be provided on the power supply control device 10.

The external connection of the power supply control device 10 is also described below. The external terminal T1 (=a power terminal) is connected to an input terminal of the input voltage Vin. The external terminal T2 (=a switch terminal) is connected to a first terminal of the inductor L1. The external terminal T3 (=a ground terminal) is connected to a ground terminal PGND. Moreover, a potential to be applied to the ground terminal PGND is sometimes referred to a ground potential PGND (=0 V) below. A second terminal of the inductor L1, and respective first terminals of the capacitor Co and the resistor R1 are connected to an output terminal of the voltage Vout (=a first terminal of the load Z). A second terminal of the resistor R1 and a first terminal of the resistor R2 are both connected to the external terminal T4 (=a feedback terminal). Respective second terminals of the capacitor Co, the resistor R2 and the load Z are all connected to the ground terminal PGND.

### [Power Supply Control Device]

The internal configuration of the power supply control device 10 is described below. The power supply control device 10 includes an output element 11, a rectifying element 12, an error amplifier 13, a phase compensation circuit 14, a slope voltage generating circuit 15, a reset comparator 16, a reference voltage generating circuit 17, a skip comparator 18, an oscillator 19, a controller 1A, a driver 1B and a zero-crossing detection circuit 1C.

The output element 11 and the rectifying element 12 are switching elements forming the half-bridge output stage HB of the switching power supply 1 (both being metal-oxide-semiconductor field-effect transistors (MOSFETs)), and perform a switching drive in a complementary manner according to gate signals G1 and G2. It is to be noted that the term “complementary” herein is understood as including not only a situation where the output element 11 and the rectifying element 12 have totally opposite turn-on/turn-off states, but also a situation where both are provided with an concurrent off time (the so-called dead time).

Regarding a connection relationship, the drain of the output element 11 is connected to the external terminal T1. The source of the output element 11 and the drain of the rectifying element 12 are both connected to the external terminal T2. The source of the rectifying element 12 is connected to the external terminal T3. The respective gates of the output element 11 and the rectifying element 12 are connected to application terminals of the gate signals G1 and G2, respectively. Moreover, a P-channel MOSFET may also be used as the output element 11, and a diode may also be used as the rectifying element 12. That is to say, the means for rectifying the switching power supply 1 is not limited to synchronous rectification, and diode rectification may also be adopted. In addition, at least one between the output element 11 and the rectifying element 12 may be placed externally on the power supply control device 10.

In the half-bridge output stage HB, the output element 11 is turned on and the rectifying element 12 is turned off when the gate signal G1 is at a high level and the gate signal G2 is at a low level. As a result, an upper-side inductor current I11 flows along a current path from the external terminal T1 through the output element 11 to the external terminal T2, and electric energy is stored in the inductor L1. The state above is equivalent to an on time Ton of the half-bridge output stage. On the other hand, the output element 11 is turned off and the rectifying element 12 is turned on when the gate signal G1 is at a low level and the gate signal G2 is at a high level. As a result, a lower-side inductor current I12 continuously flows along a current path from the external terminal T3 through the rectifying element 12 to the external terminal T2, until the electric energy stored in the inductor L1 is depleted. The state above is equivalent to an off time T_{off} of the half-bridge output stage.

By repeating the switching drive above, a switching voltage Vsw in rectangular waves is present at the external terminal T2. Thus, the switching voltage Vsw is smoothed by the inductor L1 and the capacitor C0, thereby obtaining a direct-current (DC) output voltage Vout.

The error amplifier 13 generates an error voltage V0 at an output terminal by outputting an error current I0 corresponding to a difference between a feedback voltage Vfb (=a divided voltage of the output voltage Vout) input from the external terminal T4 to an inverting input terminal (−) and a predetermined reference voltage Vref input to a non-inverting terminal (+). Specifically in brief, when Vfb<Vref, the error current I0 flows from the error amplifier 13 to the phase compensation circuit 14 so that the error voltage V0 rises. Conversely, when Vfb>Vref, the error current I0 is drawn from the phase compensation circuit 14 to the error amplifier 13 so that the error voltage V0 drops. Moreover, an absolute value of the error current I0 increases as the difference between the feedback voltage Vfb and the reference voltage Vref increases.

The phase compensation circuit 14 is an RC circuit connected between an output terminal of the error amplifier 13 and the ground terminal. Moreover, a phase compensation capacitance value and a phase compensation resistance value are appropriately set by individually taking an output feedback loop gain into consideration. In addition, the phase compensation circuit 14 may be partially or entirely disposed outside the power supply control device 10.

The slope voltage generating circuit 15 generates a slope voltage V1 of a ramp waveform corresponding to the inductor current IL flowing in the half-bridge output stage HB described above. The drawing depicts an example detecting the upper-side inductor current I11 flowing in the output element 11 and using the detection result (=an upper-side detection voltage VsH) to assign current information to the slope voltage V1, and the feedback means of the inductor current IL is not limited. For example, as illustrated in a second embodiment or a third embodiment below, the low-side inductor current I12 flowing in the rectifying element 12 may also be detected.

The slope voltage generating circuit 15 is configured to generate the slope voltage V1 of a ramp waveform having a slope dependent on the input voltage Vin. The configuration and operation of the slope voltage generating circuit 15 are to be described in detail later.

The reset comparator 16 generates a reset signal RST by comparing the error voltage V0 to be input to an inverting terminal (−) and the slope voltage V1 to be input to a non-inverting terminal (+). Thus, the reset signal RST is at a high level when V0<V1, and the reset signal RST is at a low level when V0>V1.

The reference voltage generating circuit 17 generates a consulting voltage V2 dependent on the output voltage Vout. The configuration and operation of the reference voltage generating circuit 17 are to be described in detail later.

The skip comparator 18 generates a skip signal SKIP by comparing the error voltage V0 to be input to an inverting terminal (−) and the consulting voltage V2 to be input to a non-inverting terminal (+). Thus, the skip signal SKIP is at a low level when V0>V2, and the skip signal SKIP is at a high level when V0<V2.

The oscillator 19 generates a set signal SET of a fixed frequency fsw.

The controller 1A generates control pulse signals S1 and S2 by performing a switching drive of the half-bridge output stage in either a fixed on-time control operation or a fixed frequency current mode operation by receiving respective inputs of the set signal SET, the reset signal RST and the skip signal SKIP. The switching drive performed by the controller 1A is to be described in detail later.

The driver 1B generates the gate signals G1 and G2 based on the control pulse signals S1 and S2. For example, the driver 1B sets the gate signal G1 to a high level when the control pulse signal S1 is at a high level, and sets the gate signal G1 to a low level when the control pulse signal S1 is at a low level. Moreover, the driver 1B sets the gate signal G2 to a high level when the control pulse signal S2 is at a high level, and sets the gate signal G2 to a low level when the control pulse signal S2 is at a low level.

The zero-crossing detection circuit 1C generates a backflow detection signal S3 by comparing the switching voltage Vsw (=PGND−I12*R12) generated during the off time T_{off} (=a period in which the output element 11 is turned off and the rectifying element 12 is turned on) of the half-bridge output stage HB with the ground potential PGND. When Vsw<PGND, the backflow detection signal S3 is, for example, at a low level (=a logic level in a normal state), and when Vsw>PGND, the backflow detection signal S3 is at a high level (=a logic level during the backflow detection). That is to say, during the off time T_{off} of the half-bridge output stage HB, the electric energy of the inductor L1 is depleted to lead a state in which the lower-side inductor current I12 flows from the external terminal T2 through the rectifying element 12 to the external terminal T3 (=a backflow state), and the backflow detection signal S3 rises from a low level to a high level.

Further, the controller 1A receives an input of the backflow detection signal S3, and sets both the control pulse signals S1 and S2 to a low level when the backflow detection signal S3 rises to a high level. Accordingly, both the output element 11 and the rectifying element 12 are turned off, and the half-bridge output stage becomes in an output high-impedance state (HiZ). As a result, the backflow of the lower-side inductor current I12 is cut off, hence improving the efficiency for a light load.

### [Fundamental Switching Control (Fixed Frequency Current Mode Operation)]

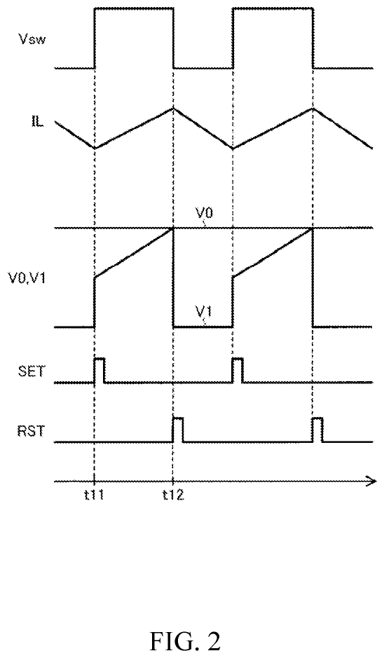

FIG. 2 shows a diagram of an exemplary fundamental switching control performed by the controller 1A, and depicts sequentially the switching voltage Vsw, the inductor current IL, the error voltage V0, the slope voltage V1, the set signal SET and the reset signal RST from top to bottom.

At an instant t11, when a pulse in the set signal SET is generated, in the controller 1A, respective logic levels of the pulse control signals S1 and S2 are switched to turn on the output element 11 and turn off the rectifying element 12. As a result, the inductor current IL changes from decreasing to increasing, the slope voltage V1 starts rising. Moreover, the switching voltage Vsw rises from a low level (≈PGND) to a high level (≈Vin).

Then, at an instant t12, the reset signal RST rises to a high level when the slope voltage V1 exceeds the error voltage V0. At this point, the controller 1A switches the respective logic levels of the pulse control signals S1 and S2 to turn off the output element 11 and turn on the rectifying element 12. As a result, the inductor current IL changes from increasing to decreasing. In addition, because the slope voltage V2 rapidly drops to 0 V, the reset signal RST drops without any delay to a low level. Moreover, the switching voltage Vsw drops from a high level (Vin) to a low level (PGND).

After the instant t12, the same actions are repeated. Thus, the fundamental switching control of the controller 1A is performing the switching drive of the half-bridge output stage in the fixed frequency current mode. Specifically in brief, the controller 1A performs pulse width modulation (PWM) control of a current mode control mode in synchronization with the set signal SET of the fixed frequency fsw.

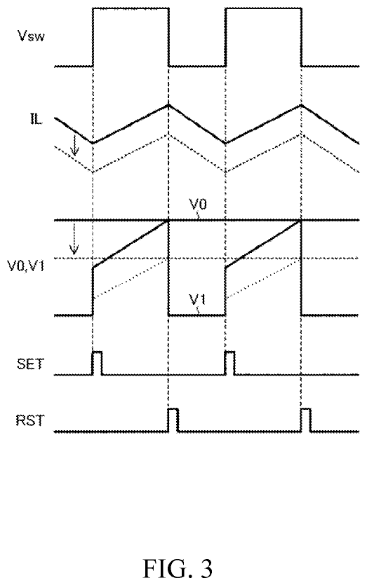

FIG. 3 shows a diagram of a situation in which waveforms vary with changes in a load (in the drawing, the output current Iₒᵤₜ flowing in the load Z decreases) in the fundamental switching control, and similar to FIG. 2, depicts sequentially the switching voltage Vsw, the inductor current IL, the error voltage V0, the slope voltage V1, the set signal SET and the reset signal RST from top to bottom.

As a type of fundamental switching control of a current control mode, the error voltage V0 also changes with changes in the output current Iₒᵤₜ (even an average of the inductor current IL). To describe with reference to the drawing, the inductor current IL decreases from a solid to a dotted line, the error voltage V0 also decreases from a solid line to a dotted line. That is to say, when the amount of charging on the capacitor Co becomes overly large due to the decrease in the output current Iₒᵤₜ, the output voltage Vout increases and the error voltage V0 even decreases.

### [Pulse Skip Control]

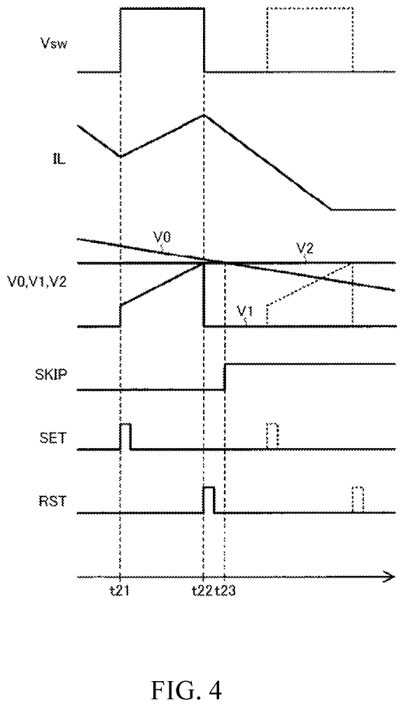

FIG. 4 shows a diagram of an exemplary pulse skip control performed by the controller 1A, and depicts sequentially the switching voltage Vsw, the inductor current IL, the error voltage V0, the slope voltage V1, the consulting voltage V2, the skip signal SKIP, the set signal SET and the reset signal RST from top to bottom. Moreover, in the drawing, the consulting voltage V2 is a fixed value.

Before an instant t23, V0>V2, and thus the skip signal SKIP is persistently kept at a low level. At this point, the controller 1A implements the switching drive of the half-bridge output stage HB according to the set signal SET and the reset signal RST in the fixed frequency current mode operation as described above. That is to say, behaviors before the instant t23 are the same as those between the instants t11 to t12 in FIG. 2, and are omitted herein for brevity.

On the other hand, as the output current Iₒᵤₜ decreases, at the instant t23, the skip signal SKIP rises from a low level to a high level when the error voltage V0 is lower than consulting voltage V2. At this point, the controller 1A implements the pulse skip control. Specifically in brief, the controller 1A shields the set signal SET, and suspends the switching drive of the half-bridge output stage (the fundamental switching control described above). Moreover, the dotted lines represent voltage pulses that may be generated in the set signal SET and the reset signal RST and waveforms that may be generated in the switching voltage Vsw and the slope voltage V1 if the pulse skip control is not performed.

Thus, when the switching power supply 1 is in a light load state (=a state in which the output current Iₒᵤₜ is smaller), switching loss can be inhibited by performing the pulse skip control above, hence improving the efficiency for a light load.

Moreover, when the pulse skip control above is performed, the set signal SET may be shielded by the controller 1A, or an oscillation operation of the oscillator 19 is stopped.

[Recovery Operation from Pulse Skip Control]

Next, a recovery operation from the pulse skip control is discussed below. As a recovery operation from the pulse skip control, the shielding on the set signal SET is released at a timing at which the output current Iₒᵤₜ increases and the skip signal SKIP drops to a low level, and the fundamental switching control above is again started.

However, if the timing of the oscillation operation (=an operation for generating the pulse of the set signal SET) and the timing at which the skip signal SKIP drops are asynchronous, a gap between the timing at which the skip signal SKIP drops and the timing at which the pulse of the set signal SET is generated is increased. Thus, there are concerns for a reduced output and increased fluctuation in the output.

In view of the undesirable conditions above, it would be ideal that the timing at which the skip signal SKIP drops and the timing of the re-started pulse generation of the set signal SET are synchronous, that is, the timing of pulse generation of the set signal SET is initialized. With the configuration above, a reduced output and increased fluctuation in the output can be inhibited.

### [Fixed On-Time Control Operation]

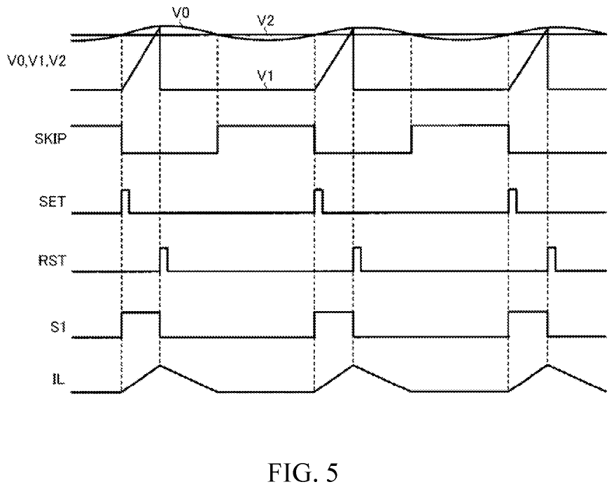

FIG. 5 shows a diagram of an exemplary fixed on-time control operation, and depicts sequentially the error voltage V0, the slope voltage V1, the consulting voltage V2, the skip signal SKIP, the set signal SET, the reset signal RST, the control pulse signal S1 and the inductor current IL from top to bottom.

Moreover, the drawing illustrates an embodiment in which the output current Iₒᵤₜ is smaller, and the fundamental switching control (FIG. 2) and the pulse skip control (FIG. 4) described above are alternately repeated. Specifically in brief, a series of operations are repeated in the embodiment of the drawing, that is, dropping of the skip signal SKIP→recovery to the fundamental switching control (generation of the one-shot pulse of the set signal SET)→dropping of the error signal V0 caused by rising of the output voltage Vout→rising of the skip signal SKIP→transfer to the pulse skip control (shielding of the set signal SET)→rising of the error voltage V0 caused by dropping of the output voltage Vout→dropping of the skip signal SKIP.

With the series of operations, the error voltage V0 is stabilized in vicinity of the consulting voltage V2 in the embodiment of the drawing. Further, when the slope of the slope voltage V1 during a high level period of the control pulse signal S1 is fixed, the high level period of the control pulse signal S1 arises each time the pulse in the set signal SET is generated also becomes a substantially fixed length. In view of the above, in the embodiment of the drawing, it may be said that a control substantially equivalent to the fixed on-time control operation is performed.

Moreover, an interval of pulse generation of the set signal SET in the fixed on-time control operation is determined according to the output current Iₒᵤₜ. Specifically, the interval of pulse generation of the set signal SET gets shorter as the output current Iₒᵤₜ increases. In addition, when the interval of the pulse generation of the set signal SET narrows to a predetermined interval, the set signal SET is no longer shielded, and the control is switched to the fundamental switching control above.

As described above, according to the controller 1A, the fixed on-time control operation is performed in a light load state (=equivalent to a first load state), and the fixed frequency current mode operation is performed in a heavy load state (=equivalent to a second load state with a load heavier that of the first load state), implementing a mixed control corresponding to the load state.

### [Seamless Mode Switching]

In order to perform seamless mode switching between the fixed on-time control operation in a light load state and the fixed frequency current mode operation in a heavy load state, the key is to provide the output element 11 with a consistent on time before and after mode switching. A method for achieving such target is disclosed below.

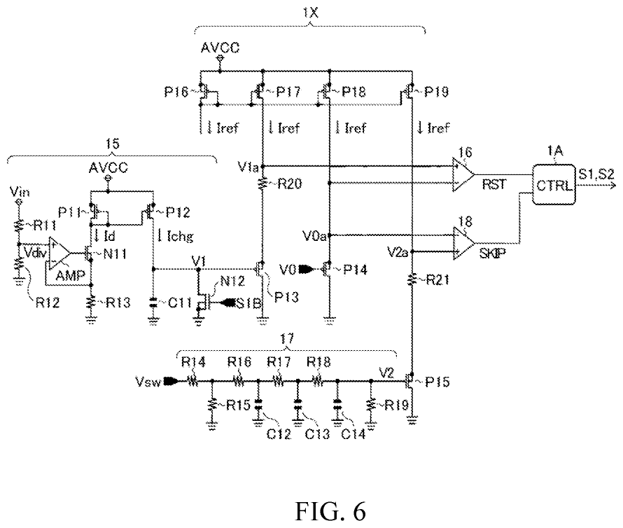

FIG. 6 shows a diagram of a main part (the slope voltage generating circuit 15, the reference voltage generating circuit 17 and its peripheral circuits) of the power supply control device 10 according to a first embodiment.

The slope voltage generating circuit 15 is first described. In the drawing, the slope voltage generating circuit 15 includes N-channel MOSFETs N11 and N12, P-channel MOSFETs P11 and P12, resistors R11 to R13, a capacitor C11, and an operational amplifier AMP.

The resistors R11 and R12 are connected in series between an application terminal of the input voltage Vin and a ground terminal. A connection node of the resistor R11 and the resistor R12 is equivalent to an output terminal of a divided voltage Vdiv (={R12/(R11+R12}*Vin) corresponding to the input voltage Vin. A non-inverting input terminal (+) of the operational amplifier AMP is connected to the connection node of the resistor R11 and the resistor R12. An inverting input terminal (−) of the operational amplifier AMP is connected to the source of the transistor N1 and a first terminal of the resistor R13. An output terminal of the operational amplifier AMP is connected to the gate of the transistor N1. A second terminal of the output resistor R13 is connected to the ground terminal.

Respective sources of the transistors P11 and P12 are both connected to an application terminal of a power supply voltage AVCC. Respective gates of the transistors P11 and P12 are both connected to the drain of the transistor P11. The drain of the transistor P11 is connected to the drain of the transistor N11.

Respective drains of the transistors P12 and N12 and a first terminal of the capacitor C11 are all connected to an output terminal of the slope voltage V1. A second terminal of the capacitor C11 and the source of the transistor N12 are both connected to the ground terminal. The gate of the transistor N12 is connected to an application terminal of an inverted control pulse signal S1b (=equivalent to a signal formed by inverting a logic level of the control pulse signal S1).

In the slope voltage generating circuit 15 including the configuration above, the operational amplifier AMP performs a gate control of the transistor N11 by a virtual short circuit between the non-inverting input terminal (+) and the inverting input terminal (−). As a result, a drain current Id (=Vdiv/R13) corresponding to the divided voltage Vdiv (or even the input voltage Vin) flows in the drain of the transistor N11. Moreover, the transistors P11 and P12 form a so-called current mirror, and duplicate the drain current Id to generate a charging current Ichg (=α*Id, where α is a mirror ratio) of the capacitor C11. That is to say, the transistor N11, the transistors P11 and P12, the resistors R11 to R13 and the operational amplifier AMP serve and function as a charging current generator that generates the charging current Ichg corresponding to the input voltage Vin.

Moreover, the transistor N12 serves and functions as a charging/discharging switch that performs charging/discharging switching on the capacitor C11 in synchronization with the inverted control pulse signal S1B. Specifically in brief, during a low level period of the inverted control pulse signal S1B (=the on time of the output element 11), the transistor N12 is turned off and thus the capacitor C11 is charged by the charging current Ichg. On the other hand, during a high level period of the inverted control pulse signal S1B (=the off time of the output element 11), the transistor N12 is turned on and thus the capacitor C11 is rapidly discharged.

Moreover, the slope voltage generating circuit 15 uses and outputs a charging voltage of the capacitor C11 as the slope voltage V1. Thus, the slope voltage V1 forms a ramp waveform, that is, it rises by a slope corresponding to the charging current Icg when the output element 11 is turned on, and rapidly drops to a zero value when the output element 11 is turned off.

Herein, the charging current Ichg has characteristics dependent on the input voltage Vin. That is to say, the charging current Ichg increases as the input voltage Vin gets higher, and hence the slope of the slope voltage V1 also becomes steep. As a result, since an intersecting timing of the error voltage V0 and the slope voltage V1 is advanced, the on time of the output element is reduced. Conversely, the charging current Ichg decreases as the input voltage Vin gets lower, and hence the slope of the slope voltage V1 also becomes moderate. As a result, since an intersecting timing of the error voltage V0 and the slope voltage V1 is postponed, the on time of the output element 11 is increased.

Next, the reference voltage generating circuit 17 is described. In the drawing, the reference voltage generating circuit 17 includes resistors R14 to R19 and capacitors C12 to C14.

A first terminal of the resistor R14 is connected to an application terminal of the switching voltage Vsw. A second terminal of the resistor R14 is connected to respective first ends of the resistors R15 and R16. A second terminal of the resistor R16 is connected to respective first ends of the resistor R17 and the capacitor C12. A second terminal of the resistor R17 is connected to respective first ends of the resistor R18 and the capacitor C13. A second terminal of the resistor R18 and respective first terminals of the resistor R19 and the capacitor C14 are all connected to an output terminal of the consulting voltage V2. Respective second terminals of the resistors R16 and R191 and the capacitors C12 to C14 are all connected to the ground terminal.

As such, the reference voltage generating circuit 17 includes a voltage divider and a multi-stage low-pass filter, and generates the consulting voltage V2 by dividing and smoothing the rectangular wave switching voltage Vsw. That is to say, the consulting voltage V2 is a voltage signal equivalent to the output voltage Vout, and has characteristics dependent on an on load Don (=Vout/Vin) of the half-bridge output stage. Specifically in brief, the consulting voltage V2 gets higher as the on load Don increases, and the consulting voltage V2 gets lower as the on load Don decreases. Moreover, focusing on the input voltage Vin, the consulting voltage V2 gets lower as the input voltage Vin increases and the consulting voltage V2 gets higher as the input voltage Vin decreases.

Next, respective output stages 1X of the reset comparator 16 and the skip comparator 18 are described below. In the drawing, the input stage 1X includes P-channel MOSFETs P13 to P19 and resistors R20 and R21.

Respective sources of the transistors P16 and P19 are all connected to an application terminal of a power supply voltage AVCC. Respective gates of the transistors P16 and P19 are all connected to the drain of the transistor P16. As such, the connected transistors P16 to P19 serve and function as a current mirror, which duplicates the reference current Iref to be input to the drain of the transistor P16 and outputs the reference current Iref from the drains of the transistors P17 to P19.

The drain of the transistor P17 and a first terminal of the resistor R20 serve as application terminals of a node voltage V1a connected to the non-inverting terminal (+) of the reset comparator 16. A second terminal of the resistor R20 is connected to the source of the transistor P13. The gate of the transistor P13 is connected to an application terminal of the slope voltage V1. The drain of the transistor P13 is connected to the ground terminal. The node voltage V1a becomes a voltage signal (=V1+Vth(P13)+Iref*R20) obtained by adding the slope voltage V1 with an on threshold voltage of the transistor P13 and an inter-terminal voltage of the resistor R20. Moreover, the node voltage V1a may also be configured to switch a resistance value of the resistor R20 with a hysteresis.

The drain of the transistor P18 and the source of the transistor P14 serve as application terminals of the node voltage V0a connected to the inverting input terminal (−) of the reset comparator 16 and the inverting input terminal (−) of the skip comparator 18. The gate of the transistor P14 is connected to an application terminal of the error voltage V0. The drain of the transistor P14 is connected to the ground terminal. The node voltage V0a becomes a voltage signal (=V0+Vth(P14)) obtained by adding the error voltage V0 with an on threshold voltage of the transistor P14.

The drain of the transistor P19 and a first terminal of the resistor R21 serve as application terminals of a node voltage V2a connected to the non-inverting terminal (+) of the skip comparator 18. A second terminal of the resistor R21 is connected to the source of the transistor P15. The gate of the transistor P15 is connected to an application terminal of the consulting voltage V2. The drain of the transistor P15 is connected to the ground terminal. The node voltage V2a becomes a voltage signal (=V2+Vth(P15)+Iref*R21) obtained by adding the consulting voltage V2 with an on threshold voltage of the transistor P15 and an inter-terminal voltage of the resistor R21. Moreover, the node voltage V2a may also be configured to switch a resistance value of the resistor R21 with a hysteresis.

Hence, the reset comparator 16 and the skip comparator 18 include the input stage 1X, and the input stage X1 has a higher input impedance by respectively receiving the error voltage V0, the slope voltage V1 and the consulting voltage V2 at the gates of the transistors P13 to P15. Thus, the reset comparator 16 and the skip comparator 18 are less likely be affected by the slope voltage generating circuit 15 and the reference voltage generating circuit 17 at the front stage.

In the power supply control device 10 of the embodiment above, a slope gradient of the slope voltage V1 to be input to the reset comparator 16 has characteristics dependent on the input voltage Vin, and the consulting voltage V2 to be input to the skip comparator 18 has characteristics dependent on the output voltage Vout.

With the configuration, the skip comparator 18 functions not only as a clamp mechanism of the error voltage in a situation of a light load as described above, but also as a main comparator used for the fixed on-time control, and changes a clamp level (=the consulting voltage V2) of the error voltage V0 by keeping the on time of the output element 11 consistent before and after switching the operation mode.

Therefore, even in a situation where the switching power supply 1 needs to be drive by a wider input voltage range (for example, Vin=30 to 80 V), the on time of the output element 11 is theoretically kept consistent in both of the fixed on-time control operation and the fixed frequency current mode operation (=approximating a ratio of the on time to 1), hence achieving seamless mode switching and inhibiting an output overshoot and an output undershoot during mode switching.

### Second Embodiment

### [Switching Power Supply]

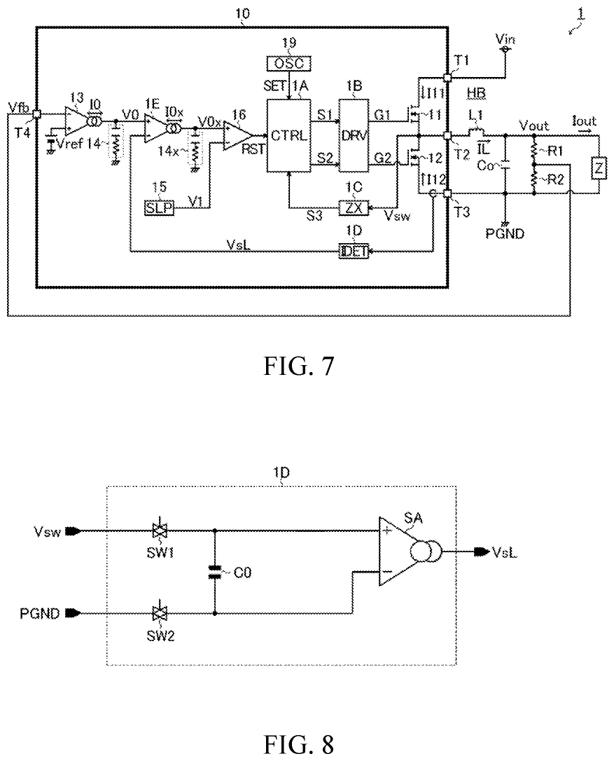

FIG. 7 shows a diagram of a switching power supply according to a second embodiment. The switching power supply 1 of this embodiment is common in majority compared to the first embodiment (FIG. 1) above, but differs in the topology of the output feedback control. Specifically, the reference voltage generating circuit 17 and the skip comparator 18 are removed, while a current detection circuit 1D, a gm amplifier 1E and a phase compensation circuit 14x are added. The same denotations as those in FIG. 1 are used for the constituent elements described above to omit such repeated description, and the description below focuses on features of this embodiment.

The current detection circuit 1D samples the switching voltage Vsw during the off time of the half-bridge output stage HB (=a period in which the output element 11 is turned off and the rectifying element 12 is turned on), and uses and the sampled switching voltage Vsw as a lower-side current detection voltage VsL for a hold output during the on time of the half-bridge output stage HB (=a period in which the output element 11 is turned on and the rectifying element 12 is turned off). Moreover, the lower-side current detection voltage VsL is equivalent to a detection result of the lower-side inductor current I12 flowing in the rectifying element 12. The configuration and operation of the current detection circuit 1D are to be described in detail shortly.

As described above, the error amplifier 13 (=equivalent to a first amplifier) generates the error voltage V0 (=equivalent to a first error voltage) corresponding to the difference between the feedback voltage Vfb and the reference voltage Vref. However, different form the first embodiment (FIG. 1), the error voltage V0 is input to the gm amplifier 1E but not the reset comparator 16.

The gm amplifier 1E (=equivalent to a second amplifier) generates an error voltage V0x at an output terminal by outputting the error current I0x, wherein the error current I0x corresponds to a difference between the error voltage V0 input from the error amplifier 13 to a non-inverting input terminal (+) and the lower-side current detection voltage VsL input from the current detection circuit 1D to an inverting input terminal (−). Specifically in brief, when V0>VsL, the error current I0 flows from the gm amplifier 1E to the phase compensation circuit 14x so that the error voltage V0x rises. Conversely, when V0<VsL, the error current I0x is drawn from the phase compensation circuit 14x to the gm amplifier 1E so that the error voltage V0x drops. Moreover, an absolute value of the error current I0x increases as the difference between the error voltage V0 and the lower-side current detection voltage VsL increases.

The phase compensation circuit 14x is an RC circuit connected between an output terminal of the gm amplifier 1E and the ground terminal. Moreover, a phase compensation capacitance value and a phase compensation resistance value are appropriately set by individually taking an output feedback loop gain into consideration. In addition, the phase compensation circuit 14x may be partially or entirely disposed outside the power supply control device 10.

The slope voltage generating circuit 15 generates a slope voltage V1 of a ramp waveform synchronous with the set signal SET.

The reset comparator 16 generates a reset signal RST by comparing the error voltage V0x to be input to a non-inverting terminal (+) and the slope voltage V1 to be input to an inverting terminal (−). Thus, the reset signal RST is at a high level when V0x>V1, and the reset signal RST is at a low level when V0x<V1.

The controller 1A generates control pulse signals S1 and S2 by performing a switching drive of the half-bridge output stage in a fixed frequency current mode operation by receiving respective inputs of the set signal SET and the reset signal RST.

### [Current Detecting Circuit]

FIG. 8 shows a diagram of a first configuration example of a current detection circuit. A current detection circuit 1D of this configuration example includes a capacitor C0, switches SW1 and SW2, and a sensing amplifier SA.

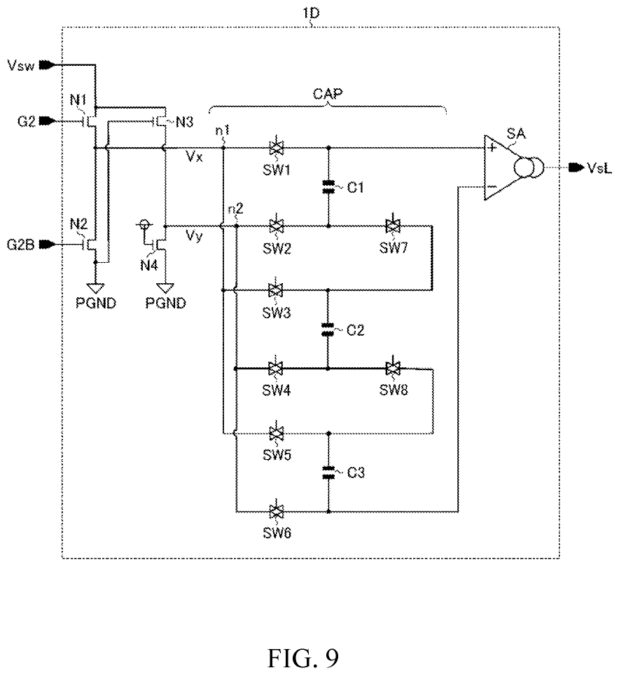

A first terminal of the switch SW1 is connected to an application terminal of the switching voltage Vsw. A second terminal of the switch SW1 and a first terminal of the capacitor C0 are both connected to a non-inverting terminal (+) of the sensing amplifier SA. A second terminal of the switch SW2 is connected to the ground terminal. Respective second terminals of the switch SW2 and the capacitor C0 are both connected to an inverting terminal (−) of the sensing amplifier SA. An output terminal of the sensing amplifier SA is connected to an application terminal of the lower-side current detection voltage VsL. Moreover, although not shown in the drawing, an input stage (for example, referring to the N-channel MOSFETs N1 to N4 in FIG. 9) that operates in synchronization with the half-bridge output stage HB is preferably disposed between the application terminal of the switching voltage Vsw and the ground and the switches SW1 and SW2.

In the current detection circuit 1D of this configuration example, both the switches SW1 and SW2 are turned on during a sampling period of the switching voltage Vsw. At this point, the capacitor C0 is charged until its inter-terminal voltage becomes substantially the switching voltage Vsw (=I12*Ron, where Ron is the on resistance value of the rectifying element 12). On the other hand, during a hold period of the lower-side current detection voltage VsL, both the switches SW1 and SW2 are turned off. At this point, the charging voltage (=Vsw) accumulated between two terminals of the capacitor C0 is output to the sensing amplifier SA. The sensing amplifier SA amplifies the charging voltage of the capacitor C0 to generate the lower-side current detection voltage VsL.

Thus, the lower-side current detection voltage VsL gets higher as the switching voltage Vsw increases, and the lower-side current detection voltage VsL gets lower as the switching voltage Vsw decreases. In other words, the lower-side current detection voltage VsL gets higher as the lower-side inductance current I12 increases, and the lower-side current detection voltage VsL gets lower as the lower-side inductance current I12 decreases.

In order to enable the switching power supply 1 to support a large output current standard, in view of reduced loss of the half-bridge output stage HB, it is necessary that the output element 12 and the rectifying element 12 be implemented by low-pass resistor devices. However, as the low-pass resistance level of the rectifying element 12 increases, the charging current (=Vsw) that can be maintained by one single capacitor C0 gets lower, and so it would be difficult to maintain a current detection gain. A novel configuration for solving the problem above is provided.

FIG. 9 shows a diagram of a second configuration example of a current detection circuit 1D. A current detection circuit 1D of this configuration example includes N-channel MOSFETs N1 to N4, a capacitor circuit CAP and a sensing amplifier SA. The capacitor circuit CAP includes capacitors C1 to C3 and switches SW1 to SW8.

Respective drains of the transistors N1 and N3 are both connected to an application terminal of the switching voltage Vsw. The source of the transistor N1 and the drain of the transistor N2 are both connected to a node n1. The source of the transistor N3 and the drain of the transistor N4 are both connected to a node n2. Respective sources of the transistors N2 and N4 are both connected to a ground terminal PGND. The gate of the transistor N1 is connected to an application terminal of a gate signal G2. The gate of the transistor N2 is connected to an application terminal of an inverted control pulse signal G2B (=equivalent to a signal formed by inverting a logic level of the gate signal G2). The gate of the transistor N3 is connected to the ground terminal PGND. The gate of the transistor N4 is connected to a power supply terminal.

The transistor N1 equivalent to a first transistor is connected between an application terminal of the switching voltage Vsw and the node n1, and is configured to be turned on during an off time T_{off} (G1=L, G2=H) of the half-bridge output stage HB and to be turned off during an on period Ton (G1=H, G2=L) of the half-bridge output stage HB. The transistor N2 equivalent to a second transistor is connected between the node n1 and the ground terminal PGND, and is configured to be turned off during the off time T_{off} of the half-bridge output stage HB and to be turned on during the on time Ton of the half-bridge output stage HB. In view of the operations above, a node voltage Vx present at the node n1 becomes the ground potential PGND during the on time Ton of the half-bridge output stage HB, and becomes the switching voltage Vsw during the off time T_{off} of the half-bridge output stage HB.

Moreover, the transistor N3 equivalent to a third transistor is connected between the application terminal of the switching voltage Vsw and the node n2, and is configured to be constantly turned off. Moreover, the transistor N4 equivalent to a fourth transistor is connected between the application terminal of the node n2 and the ground terminal PGND, and is configured to be constantly turned on. Thus, a node voltage Vy present at the node n2 is constantly the ground voltage PGND. In addition, by disposing the transistors N3 and N4, respective input impedances at the nodes n1 and n2 can be matched.

Respective first terminals of the switches SW1, SW3 and SW5 are all connected to the node n1. Respective second terminals of the switches SW2, SW4 and SW6 are all connected to the node n2. A second terminal of the switch SW1 and a first terminal of the capacitor C1 are both connected to a non-inverting terminal (+) of the sensing amplifier SA. Respective second terminals of the switch SW2 and the capacitor C1 are both connected to a first terminal of the switch SW7. A second terminal of the switch SW3 and a first terminal of the capacitor C2 are both connected to a second terminal of the switch SW7. Respective second terminals of the switch SW4 and the capacitor C2 are both connected to a first terminal of the switch SW8. A second terminal of the switch SW5 and a first terminal of the capacitor C32 are both connected to a second terminal of the switch SW8. Respective second terminals of the switch SW6 and the capacitor C3 are both connected to an inverting terminal (−) of the sensing amplifier SA. An output terminal of the sensing amplifier SA is connected to an application terminal of the lower-side current detection voltage VsL.

In the current detection circuit 1D of this configuration example, all the switches SW1 to SW6 are turned on and both the switches SW7 and SW8 are turned off during a sampling period of the switching voltage Vsw. At this point, the capacitors C1 to C3 become a parallel connection state between the node n1 (=an application terminal of the switching voltage Vsw) and the node n2 (=the ground terminal PGND). Thus, the capacitors C1 to C3 are charged until respective inter-terminal voltages become substantially the switching voltage Vsw.

On the other hand, during a hold period of the lower-side current detection voltage VsL, all the switches SW1 to SW6 are turned off and both the switches SW7 and SW8 are turned on. At this point, the capacitors C1 to C3 become a serial connection state between the non-inverting terminal (+) and the inverting terminal (−) of the sensing amplifier SA. Hence, the charging voltage (=V3*Vsw) accumulated between two terminals of a capacitor row including the capacitors C1 to C3 is output to the sensing amplifier SA. The sensing amplifier SA amplifies the charging voltage of the capacitor row to generate the lower-side current detection voltage VsL.

As such, the switches SW1 to SW8 are equivalent to a switch group, which is configured to set the capacitors C1 to C3 to a parallel connection state during the sampling period of the switching voltage, and to set the capacitors C1 to C3 to a serial connection state during the hold period of the lower-side current detection voltage VsL.

Moreover, the switch group may be understood as the following categories: a first switch (SW1, SW3 and SW5) connected between the node n1 and the respective first terminals of the capacitors C1 to C3, a second switch (SW2, SW4 and SW6) connected between the node n2 and the respective second terminals of the capacitors C1 to C3, and a third switch (SW7 and SW8) connected between the capacitors C1 to C3.

Moreover, in the current detection circuit 1D of this configuration example, the capacitor circuit CAP may function as a varactor, which is configured to have a first capacitance value (=C1+C2+C3) during the sampling period of the switching voltage Vsw, and to have a second capacitance value (=C1/C2//C3) smaller than the first capacitance value during the hold period of the lower-side current detection voltage VsL.

With the configuration and the setting above, even if the on resistance of the rectifying element 12 is low, information of the lower-side inductance current I12 can still be more reliably extracted. Therefore, the current detection gain of the current detecting current 1D can be maintained, improving the stability of the lower-side inductor current detection type current mode control.

Moreover, the drawing depicts the capacitor circuit CAP capable of boosting the sampled switching voltage Vsw to three times for a hold output. However, the boosting multiple may be adjusted as desired by increasing or decreasing the number of capacitors to be connected in series or to be connected in parallel. In addition, the capacitor circuit CAP only needs to be appropriately designed such that the second capacitance value (C1//C2//C3) above is able to smoothly maintain the lower current detection voltage VsL during the on time of the half-bridge output stage HB.

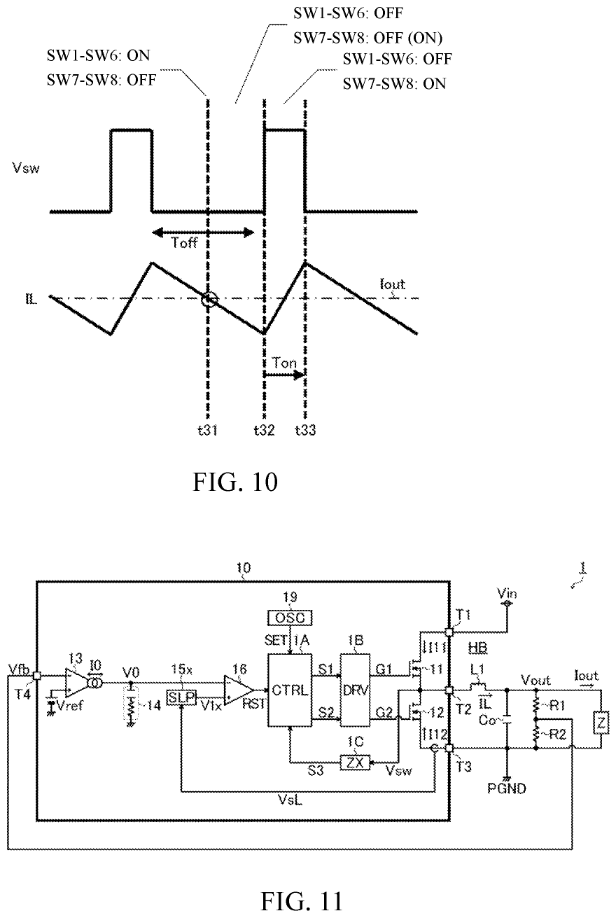

FIG. 10 shows a diagram of an exemplary operation of a current detection circuit 1D of second configuration example, and depicts the switching voltage Vsw and the inductor current IL.

An instant t31 represents a sampling timing of the switching voltage Vsw. At this timing, the switches SW1 to SW6 are turned on and the switches SW7 and SW8 are turned off, accordingly sampling the switching voltage Vsw using the capacitors C1 to C3 that are connected in series.

The sampling timing of the switching voltage Vsw may be arbitrary provided that it is within the off time of the half-bridge output stage HB. In particular, as shown by the instant t31, the sampling timing is ideally a timing at ½ of the off time T_{off} (=equivalent to a timing at ½ of the off time T_{off}). An average of the inductor current IL, that is, current information related to the output current Iₒᵤₜ, can be obtained by sampling the switching voltage Vsw at this timing.

On the other hand, instants t32 to t33 indicate the on time Ton of the half-bridge output stage HB. At this point, the switches SW1 to SW6 are turned off and the switches SW7 and SW8 are turned on, accordingly using the lower-side current detection voltage VsL(=3*Vsw) for hold output by the capacitors C1 to C3 that are connected in series.

After the sampling of the switching voltage Vsw is complete and before the period of the hold output of the lower-side current detection voltage VsL begins, the switches SW1 to SW6 are turned off at the instants t31 to t32, and the turning on/off of the switches SW7 and SW8 are not specifically limited.

### Third Embodiment

### [Switching Power Supply]

FIG. 11 shows a diagram of a switching power supply according to a third embodiment. The switching power supply 1 of this embodiment is common in majority compared to the second embodiment (FIG. 7) above, but differs in the topology of the output feedback control. Specifically, the current detection circuit 1D, the gm amplifier 1E and the phase compensation circuit 14x described above are removed, while a slope voltage generating circuit 15x also having a current detection function is provided in substitution for the slope voltage generating circuit 15. The same denotations as those in FIG. 7 are used for the constituent elements described above to omit such repeated description, and the description below focuses on features of this embodiment.

The slope voltage generating circuit 15x generates a slope voltage V1x, which is obtained by adding the lower-side current detection voltage VsL corresponding to the lower-side inductor current I12 flowing in the rectifying element 12 and a slope voltage Vramp synchronous with the set signal SET. The configuration and operation of the slope voltage generating circuit 15x are to be described in detail shortly.

The reset comparator 16 generates a reset signal RST by comparing the error voltage V0 to be input from the error amplifier 13 to an inverting terminal (−) and the slope voltage V1x to be input from the slope voltage generating circuit 15x to a non-inverting terminal (+). Thus, the reset signal RST is at a high level when V0<Vx1, and the reset signal RST is at a low level when V0>V1x.

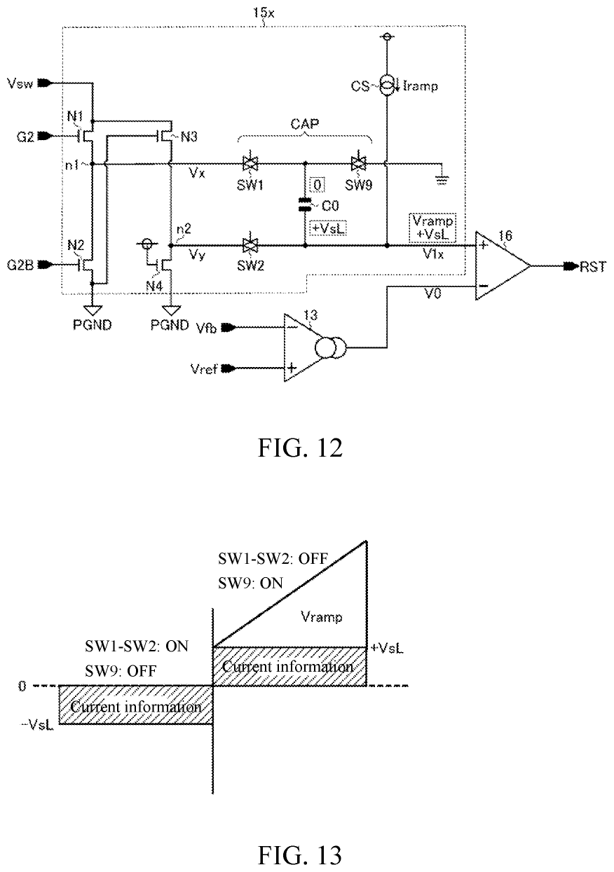

FIG. 12 shows a diagram of a main part (the slope voltage generating circuit 15x and its peripheral circuits) of the power supply control device 10 according to the third embodiment. The slope voltage generating circuit 15x of this configuration example includes N-channel MOSFETs N1 to N4, a capacitor circuit CAP and a current source CS. The configuration and operation of the input stage including the transistors N1 to N4 are the same as those in FIG. 9 described above and the associated description is omitted herein, and the description below focuses on features of this embodiment.

The capacitor circuit CAP is fundamentally a sampling/hold circuit that samples the switching voltage Vsw during the off time of the half-bridge output stage HB and uses the switching voltage Vsw as the lower-side current detection voltage VsL for a hold output, and includes a capacitor C0 and switches SW1, SW2 and SW9. A first terminal of the switch SW1 is connected to the node n1. A second terminal of the switch SW1 is connected to respective first terminals of the capacitor C0 and the switch SW9. A second terminal of the switch SW9 is connected to the ground terminal. A first terminal of the switch SW2 is connected to the node n2. Respective second terminals of the switch SW2 and the capacitor C0 are both connected to the non-inverting terminal (+) of the reset comparator 16. Moreover, the switch SW9 does not form the sampling/hold circuit, but is configured as a mechanism that adds the lower-side current detection voltage VsL with a slope voltage Vramp to be described below.

The current source CS is connected between a power supply terminal and the second terminal of the capacitor C0, and a charging current Iramp flows along a current path through the capacitor C0 and the switch SW9 to the ground terminal PGND during the on time Ton of the half-bridge output stage HB. By the charging operation above, a superimposing processing of current information and a ramp waveform can be implemented, that is, a process for generating the slope voltage V1x, wherein the slope voltage V1x is obtained by adding the lower-side current detection voltage VsL with the slope voltage Vramp.

FIG. 13 shows a schematic diagram of a superimposing process of current information and a ramp waveform. In the slope voltage generating circuit 15x of this configuration example, the switches SW1 and SW2 are turned on and the switch SW9 is turned off during a sampling period of the switching voltage Vsw. At this point, the capacitor C0 is charged until an inter-terminal voltage becomes substantially the switching voltage Vsw. The charging voltage is equivalent to the lower-side detection voltage VsL (=current information related to the lower-side inductor current I12). Moreover, the switching voltage Vsw is in a negative potential relative to the ground potential PGND (=0 V). Thus, the first terminal of the capacitor C0 completely charged becomes a low potential terminal (=−Vsw=−VsL), and the second terminal becomes a high potential terminal (=PGND=0 V).

On the other hand, during a hold period of the lower-side current detection voltage VsL, both the switches SW1 and SW2 are turned off and the switches SW9 is turned on. That is to say, during the hold output of the lower-side current detection voltage VsL, the first terminal (=the low potential terminal) of the capacitor C0 is in a grounded state. As a result, following the law of conservation of charge of the capacitor C0, a level of the second terminal (=the high potential terminal) of the capacitor C0 shifts from the ground potential to a positive potential (=+VsL).

In addition, at this point, the charging current Iramp flows along a current path from the current source CS through the capacitor C0 and the switch SW9 to the ground terminal PGND. As a result, the inter-terminal voltage of the capacitor C0 is added to the previously accumulated lower-side current detection voltage VsL and continuously rises according to a slope corresponding to the charging current Iramp. That is to say, the slope voltage V1x output from the second terminal of the capacitor C0 then has a voltage value obtained by adding the slope voltage Vramp to the lower-side current detection voltage VsL.

That is to say, according to the slope voltage generating circuit 15x, one single capacitor C0 can provide both purposes of sampling/holding and generating a ramp waveform. Therefore, the number of capacitors can be reduced to thereby decrease a circuit scale.

Moreover, the current mode control can be established by directly inputting the slope voltage V1x having the current information to the reset comparator 16. That is to say, while implementing a lower-side inductor current detection type current mode control, the circuit configuration of an upper-side inductor current detection type current mode control can be directly used. Specifically, the gm amplifier 1E and the phase compensation circuit 14x of the second embodiment (FIG. 7) can be omitted, and hence the lower-side inductor current detection type current mode control can be implemented by a smaller circuit scale.

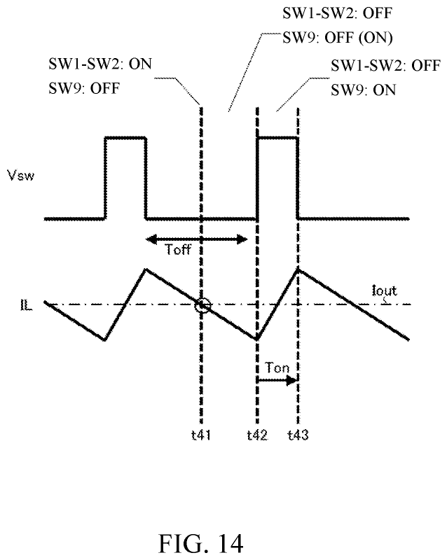

FIG. 14 shows a diagram of an exemplary operation of a slope voltage generating circuit 15x, and similarly depicts the switching voltage Vsw and the inductor current IL as in FIG. 10.

An instant t41 represents a sampling timing of the switching voltage Vsw. At this timing, the switches SW1 and SW2 are turned on and the switch SW9 is turned off, accordingly sampling the switching voltage Vsw using the capacitor C0.

The sampling timing of the switching voltage Vsw may be arbitrary, given that it is within the off time of the half-bridge output stage HB. In particular, as shown by the instant t41, the sampling timing is ideally a timing at ½ of the off time T_{off} (=equivalent to a timing at ½ of the off time T_{off}). An average of the inductor current IL, that is, current information related to the output current Iₒᵤₜ, can be obtained by sampling the switching voltage Vsw at this timing. Such perspective is the same as the second embodiment (FIG. 10) described above.

On the other hand, instants t42 to t43 indicate the on time Ton of the half-bridge output stage HB. At this point, the hold output of the lower-side current detection voltage VsL (=Vsw) charged to the capacitor can be implemented by turning on the switches SW1 and SW2 and turning off the switch SW9, and the slope voltage V1x having current information can be generated by adding the lower-side current detection voltage VsL (=Vsw) with the slope voltage Vramp.

After the sampling of the switching voltage Vsw is complete and before the period of the hold output of the lower-side current detection voltage VsL begins, the switches SW1 and SW2 are turned off at the instants t41 to t42, and the turning on/off of the switch SW9 is not specifically limited.

### Combinations of the Embodiments

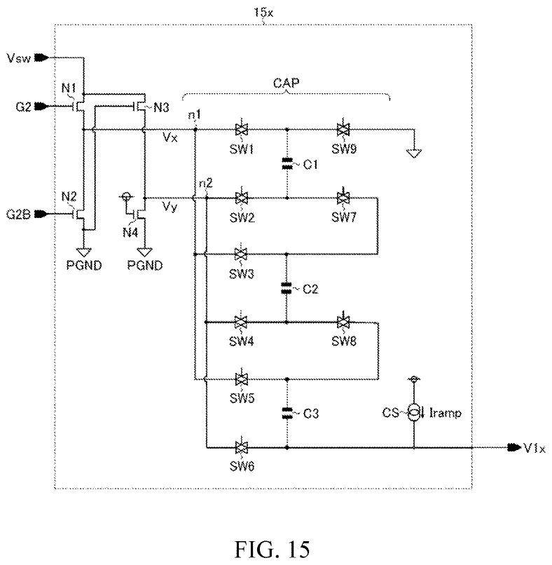

FIG. 15 is a diagram of an exemplary combination of the second embodiment (FIG. 9) and the third embodiment (FIG. 12). The slope voltage generating circuit 15x in the drawing is basically formed by the circuit configuration of the third embodiment (FIG. 12) and applying the circuit configuration of the second embodiment (FIG. 9) into a combination as a mechanism used for switching the capacitance value of the capacitor circuit CAP in each period between the sampling period of the switching voltage Vsw and the hold period of the lower-side current detection voltage VsL.

More specifically, the capacitor circuit CAP includes capacitors C1 to C3, a switch group (SW1 to SW8) and a switch SW9. The switch group (SW1 to SW8) is configured to set the capacitors C1 to C3 to a parallel connection state during the sampling period and setting the capacitors C1 to C3 to a serial connection state during the hold period. The capacitor SW9 is connected between a first terminal (=a first terminal of the capacitor C1) of a capacitor row formed by connecting the capacitors C1 to C3 in series and the ground terminal PGDN, and is configured to be turned off during the sampling period of the switching voltage Vsw and to be turned on during the hold period of the lower-side current detection voltage VsL. Moreover, the current source CS is connected to a second terminal (=a second terminal of the capacitor C3) of the capacitor row, and a charging current Iramp flows along a current path though the capacitor row and the switch SW9 to the ground terminal PGND to generate the slope voltage V1x at the second terminal of the capacitor row.

Moreover, in the slope voltage generating circuit 15x of this configuration example, the capacitor circuit CAP may function as a varactor, which is configured to have a first capacitance value (=C1+C2+C3) during the sampling period of the switching voltage Vsw, and to have a second capacitance value (=C1/C2//C3) smaller than the first capacitance value during the hold period of the lower-side current detection voltage VsL.

With the configuration and the setting above, even if the on resistance of the rectifying element 12 is low, information of the lower-side inductance current I12 can still be more reliably extracted. Therefore, the current detection gain of slope voltage generating circuit 15x can be maintained, improving the stability of the lower-side inductor current detection type current mode control.

As such, the various embodiments given in the description may be appropriately implemented in combination given that no contradictions are incurred. For example, in the first embodiment (FIG. 1) above, the circuit configuration of the upper-side inductor current detection type current mode control is given as an example; however, such application may be changed to a upper-side inductor current detection type current mode control, and a combination with the current detection circuit 1D (FIG. 9) of the second embodiment or the slope voltage generating circuit 15x (FIG. 12) of the third embodiment may be combined.

### Conclusion

A summary of the various embodiments of the description is given below.

For example, a power supply control device disclosed by the present application is configured to control an output stage of a switching power supply that generates an output voltage from an input voltage, and is configured as (first configuration), including: an error amplifier, configured to generate an error voltage according to a difference between a feedback voltage corresponding to the output voltage and a predetermined reference voltage; a slope voltage generating circuit, configured to generate a slope voltage of a ramp waveform according to an inductor current flowing during the output stage, wherein a slope of the ramp waveform depends on the input voltage; a reference voltage generating circuit, configured to generate a consulting voltage dependent on the output voltage; a reset comparator, configured to generate a reset signal by comparing the error voltage with the slope voltage; a skip comparator, configured to generate a skip signal by comparing the error voltage with the consulting voltage; an oscillator, configured to generate a set signal of a fixed frequency; and a controller, configured to perform a switching drive of the output stage in either a fixed on-time control operation or a fixed frequency current mode operation by receiving inputs of the set signal, the reset signal, and the skip signal.

In addition, a power supply control device including the first configuration may also be configured as (second configuration), wherein the controller performs the fixed on-time control operation in a first load state, and performs the fixed frequency current mode operation in a second load state in which a load is heavier than that in the first load state.

Moreover, a power supply control device including the first or second configuration may also be configured as (third configuration), wherein when the skip signal is at a first logic level, the controller performs the switching drive of the output stage according to the set signal and the reset signal, or when the skip signal is at a second logic level, the switching drive of the output stage is stopped.

Moreover, a power supply control device including any one of the first to third configurations may also be configured as (fourth configuration), wherein the slope voltage generating circuit includes: a charging current generator, configured to generate a charging current according to the input voltage; a capacitor, configured to be charged by the charging current; and a charging/discharging switch, configured to switch charge/discharge of the capacitor, wherein a charging voltage of the capacitor is output as the slope voltage.

Moreover, a power supply control device including any one of the first to fourth configurations may also be configured as (fifth configuration), wherein the reference voltage generating circuit smooths a rectangular wave switch voltage present in the output stage to generate the consulting voltage.

Moreover, a power supply control device including any one of the first to fifth configurations may also be configured as (sixth configuration), wherein the reset comparator and the skip comparator include an input stage configured to respectively receive the error voltage, the slope voltage, and the consulting voltage at gates of a plurality of field effect transistor, respectively.

Moreover, for example, a current detection circuit disclosed by the present application is configured (seventh configuration) to sample a switching voltage presented at the output stage of the switching power supply during an off time of the output stage, and use the switching voltage as a current detection voltage for a hold output during an on time of the output stage, and includes: a capacitor circuit, configured to have a first capacitance value in a sampling period of the switching voltage, and to have a second capacitance value smaller than the first capacitance value in a hold period of the current detection voltage; and a sensing amplifier, configured to generate the current detection voltage according to a charging voltage of the capacitor.

Moreover, a current detection circuit including the seventh configuration may also be configured as (eighth configuration), wherein the capacitor circuit includes a plurality of capacitors and a switch group, and the switch group sets to the plurality of capacitor to a parallel connection state during the sampling period and sets the plurality of capacitors to a serial connection state during the hold period.

Moreover, a current detection circuit including the eighth configuration may also be configured as (ninth configuration), wherein the capacitor circuit includes a plurality of first switches, a plurality of second switches and at least one third switch as the switch group, the plurality of first switches are connected between the first node and respective first terminals of the plurality of capacitors, the plurality of second switches are connected between the second node and respective second terminals of the plurality of capacitors, and the at least one third switch is connected between the plurality of capacitors.

Moreover, a current detection circuit including the ninth configuration may also be configured as (tenth configuration) further including: a first transistor, connected between an application terminal of the switching voltage and the first node, and configured to be turned on during the off time and to be turned on during the on time; a second transistor, connected between the first node and a ground terminal, and configured to be turned off during the off time and to be turned on during the on time; a third transistor, connected between the application terminal of the switching voltage and the second node, and configured to be constantly turned off; and a fourth transistor, connected between the second node and the ground terminal, and configured to be constantly turned on.

Moreover, the current detection circuit including any one of the seventh to tenth configurations may also be configured as (eleventh configuration), wherein a sampling timing of the switching voltage is set to be a timing that is at ½ of the off time.

Moreover, a power supply control device disclosed by the present application may also be configured as (twelfth configuration) including: a current detection circuit, including any one of the seventh to eleventh configurations; and a controller, configured to perform the switching drive of the output stage in the fixed frequency current mode operation based on the current detection voltage.

Moreover, a power supply control device including the twelfth configuration may also be configured as (thirteenth configuration) further including: a first amplifier, configured to generate a first error voltage corresponding to a difference between a feedback voltage corresponding to the output voltage of the switching power supply and a predetermined reference voltage; a second amplifier, configured to generate a second error voltage corresponding to a difference between the first error voltage and the current detection voltage; an oscillator, configured to generate set signal of a fixed frequency; a slope voltage generating circuit, configured to generate a slope voltage of a ramp waveform synchronous with the set signal; and a reset comparator, configured to generate a reset signal by comparing the second error voltage with the slope voltage, wherein the controller performs the switching drive of the output stage in the fixed frequency current mode operation by receiving respective inputs of the set signal and the reset signal.

Moreover, for example, a slope voltage generating circuit disclosed by the present application may also be configured as (fourteenth configuration) including: a capacitor circuit, configured to sample a switching voltage present at an output stage of a switching power supply in an off time of the output stage, and to use switching voltage as a current detection voltage for a hold output during an on time of the output stage; and a current source, generating a slope voltage obtained by adding the current detection voltage with a ramp voltage by flowing a charging current into the capacitor circuit during the on time.

Moreover, a slope voltage generating circuit including the fourteenth configuration may also be configured as (fifteenth configuration), wherein the capacitor circuit includes: a capacitor; a first switch, connected between a first terminal of the capacitor and an application terminal of the switching voltage, and configured to be turned on during a sampling period of the switching voltage and to be turned off during a hold period of the current detection voltage; a second switch, connected to between a second terminal of the capacitor and a ground terminal, and configured to be turned on during the sampling period of the switching voltage and to be turned off during the hold period of the current detection voltage; and a third switch, connected between the first terminal of the capacitor and the ground terminal, and configured to be turned off during the sampling period of the switching voltage, and to be turned on during the hold period of the current detection voltage, wherein the current source is connected to the second terminal of the capacitor, and the slope voltage is generated at the second terminal of the capacitor by flowing the charging current along a current path from the capacitor through the third switch to the ground terminal.

Moreover, a slope voltage generating circuit including the fourteenth configuration may also be configured as (sixteenth configuration), wherein the capacitor circuit is configured to have a first capacitance value during the sampling period of the switching voltage, and to have a second capacitance value smaller than the first capacitance value during the hold period of the current detection voltage.

Moreover, a slope voltage generating circuit including the sixteenth configuration may also be configured as (seventeenth configuration), wherein the capacitor circuit includes: a plurality of capacitors; a switch group, configured to set the plurality of capacitor to a parallel connection state during the sampling period and to set the plurality capacitor into a serial connection state in the hold period; and a switch, connected between a first terminal of a capacitor row formed by connecting the plurality of capacitors in series and a ground terminal, and configured to be turned off during the sampling period and to be turned on during the hold period, wherein the current source is connected to a second terminal of the capacitor row, and the slope voltage is generated at the second terminal of the capacitor row by flowing the charging current along a current path from the capacitor row through the switch to the ground terminal.

Moreover, a slope voltage generating circuit including any one of the fourteenth to seventeenth configurations may also be configured as (eighteenth configuration), wherein a sampling timing of the switching voltage is set to be a timing that is at ½ of the off time.

Moreover, for example, a power supply control device may also be configured as (nineteenth configuration) including: a slope voltage generating circuit, including any one of the fourteenth to eighteenth configurations; an error amplifier, configured to generate an error voltage corresponding to a difference between a feedback voltage corresponding to an output voltage of the switching power supply and a predetermined reference voltage; a reset comparator, configured to generate a reset signal by comparing the error voltage with the slope voltage; an oscillator, configured to generate a set signal of a fixed frequency; and a controller, configured to perform the switching drive of the output stage in a fixed frequency current mode operation by receiving respective inputs of the set signal and the reset signal.

Moreover, a switching power supply disclosed by the present application may also be configured as (twentieth configuration) including the power supply control device of any one of the first to sixth, twelfth, thirteenth and nineteenth configurations.

### Other Variation Examples

Further, in addition to the embodiments, various modifications may be made to the technical features disclosed by the present disclosure without departing from the scope of the technical inventive subject thereof. For example, mutual substitutions of bipolar transistors and MOSFETs and inversions of logic levels of various signals can be arbitrary. That is to say, it should be understood that all aspects of the embodiment are exemplary rather than limiting, and it should also be understood that the technical scope of the present disclosure is not limited to the embodiment, but includes all modifications of equivalent meanings of the claims within the scope.

1. A power supply control device, configured to control an output stage of a switching power supply that generates an output voltage from an input voltage, comprising:
an error amplifier, configured to generate an error voltage according to a difference between a feedback voltage corresponding to the output voltage and a predetermined reference voltage;
a slope voltage generating circuit, configured to generate a slope voltage of a ramp waveform according to an inductor current flowing during the output stage, wherein a slope of the ramp waveform depends on the input voltage;
a reference voltage generating circuit, configured to generate a consulting voltage dependent on the output voltage;
a reset comparator, configured to generate a reset signal by comparing the error voltage with the slope voltage;
a skip comparator, configured to generate a skip signal by comparing the error voltage with the consulting voltage;
an oscillator, configured to generate a set signal of a fixed frequency; and
a controller, configured to perform a switching drive of the output stage in either a fixed on-time control operation or a fixed frequency current mode operation by receiving inputs of the set signal, the reset signal, and the skip signal.

2. A power supply control device of claim 1, wherein the controller performs the fixed on-time control operation in a first load state, and performs the fixed frequency current mode operation in a second load state whose load is heavier than the first load state.

3. A power supply control device of claim 1, wherein
when the skip signal is at a first logic level, the controller performs the switching drive of the output stage according to the set signal and the reset signal, or when the skip signal is at a second logic level, the switching drive of the output stage is stopped.

4. A power supply control device of claim 2, wherein
when the skip signal is at a first logic level, the controller performs the switching drive of the output stage according to the set signal and the reset signal, or when the skip signal is at a second logic level, the switching drive of the output stage is stopped.

5. A power supply control device of claim 1, wherein the slope voltage generating circuit comprises:
a charging current generator, configured to generate a charging current according to the input voltage;
a capacitor, configured to be charged by the charging current; and
a charging/discharging switch, configured to switch charge/discharge of the capacitor, wherein a charging voltage of the capacitor is output as the slope voltage.

6. A power supply control device of claim 2, wherein the slope voltage generating circuit comprises:
a charging current generator, configured to generate a charging current according to the input voltage;
a capacitor, configured to be charged by the charging current; and
a charging/discharging switch, configured to switch charge/discharge of the capacitor, wherein a charging voltage of the capacitor is output as the slope voltage.

7. A power supply control device of claim 3, wherein the slope voltage generating circuit comprises:
a charging current generator, configured to generate a charging current according to the input voltage;
a capacitor, configured to be charged by the charging current; and
a charging/discharging switch, configured to switch charge/discharge of the capacitor, wherein a charging voltage of the capacitor is output as the slope voltage.

8. A power supply control device of claim 1, wherein the reference voltage generating circuit smooths a rectangular wave switch voltage present in the output stage to generate the consulting voltage.

9. A power supply control device of claim 2, wherein the reference voltage generating circuit smooths a rectangular wave switch voltage present in the output stage to generate the consulting voltage.

10. A power supply control device of claim 3, wherein the reference voltage generating circuit smooths a rectangular wave switch voltage present in the output stage to generate the consulting voltage.

11. A power supply control device of claim 5, wherein the reference voltage generating circuit smooths a rectangular wave switch voltage present in the output stage to generate the consulting voltage.

12. A power supply control device of claim 1, wherein the reset comparator and the skip comparator include an input stage configured to respectively receive the error voltage, the slope voltage, and the consulting voltage at gates of a plurality of field effect transistors.

13. A power supply control device of claim 2, wherein the reset comparator and the skip comparator include an input stage configured to respectively receive the error voltage, the slope voltage, and the consulting voltage at gates of a plurality of field effect transistors.

14. A power supply control device of claim 3, wherein the reset comparator and the skip comparator include an input stage configured to respectively receive the error voltage, the slope voltage, and the consulting voltage at gates of a plurality of field effect transistors.

15. A power supply control device of claim 5, wherein the reset comparator and the skip comparator include an input stage configured to respectively receive the error voltage, the slope voltage, and the consulting voltage at gates of a plurality of field effect transistors.

16. A switching power supply, comprising the power supply control device of claim 1.

17. A switching power supply, comprising the power supply control device of claim 2.

18. A switching power supply, comprising the power supply control device of claim 3.

19. A switching power supply, comprising the power supply control device of claim 5.

20. A switching power supply, comprising the power supply control device of claim 8.
